(19) United States
(12) Patent Application Publication
(10) Pub. No.: US 2008/0235796 A1
(43) Pub. Date: Sep. 25, 2008

(54) Circuit Arrangement with Non-Volatile Memory Module and Method for Registering Attacks on Said Non-Volatile Memory Switch

(75) Inventor: Wolfgang Buhr, Hamburg (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/063,868

(22) PCT Filed: Aug. 9, 2006
(86) PCT No.: PCT/IB06/52747

§ 371 Date: Feb. 15, 2008

(30) Foreign Application Priority Data
Aug. 19, 2005 (EP) 05107613.1

(51) Int. Cl. G06F 21/00

(52) U.S. Cl. 726/22

(57) ABSTRACT

In order to further develop a circuit arrangement (100), in particular an integrated circuit, for electronic data processing as well as a method for detecting and/or for registering and/or for signaling the irradiation of at least one non-volatile memory module (10) with at least one light source in order to be capable of securely averting an attack, in particular an E[lectro]M[agnetic] radiation attack, for example a side-channel attack, or in particular a crypto-analysis, for example a current trace analysis or a D[ifferential]P[ower]A[nalysis], such attack or such analysis in particular being targeted on finding out a private key, it is proposed that an access timing for at least one read access to the memory module (10) is generated, in particular that at least one additional read access to the memory module (10) is added in at least one test mode (T), in particular in at least one D[isable]A[ll]W[ordline] mode, this test mode (T) preferably allowing to detect if the memory module (10) is currently exposed to any light of a certain energy.

The present invention relates in general to the technical field of impeding crypto analysis, in particular of protecting at least one data processing device, in particular at least one embedded system, for example at least one chip card or smart card, against at least one attack, in particular against at least one E[lectro]M[agnetic] radiation attack, for example against at least one side-channel attack, or in particular against at least one crypto-analysis, for example against at least one current trace analysis or against at least one D[ifferential]P[ower]A[nalysis].

More specifically, the present invention relates to a circuit arrangement, in particular to an integrated circuit, for electronic data processing, this circuit arrangement comprising the features of the preamble of claim 1 (cf. prior art document WO 2004/049349 A2).

The present invention further relates to a method for detecting and/or for registering and/or for signaling the irradiation of at least one non-volatile memory module with at least one light source (so-called “light attack” on said non-volatile memory module).

The data processing device, in particular at least one integrated circuit of the data processing device, may carry out calculations, in particular cryptographic operations.

Electronic modules, such as

E[rasable]P[rogrammable]R[ead] O[nly]M[emories],
E[lectrically]E[rasable]P[rogrammable]R[ead]O[nly]M[emories] or flash memories, permit the writing and/or the reading of digital data in the form of “1” and “0”, which are frequently referred to as the written or erased state (bit).

Incorrect reading of these data can be caused by external influences, such as irradiation with strong light sources (so-called “light attack” or “light flash attack”). This incorrect reading of the data from the non-volatile memory module (so-called “N[on]V[olatile] memory”) can be countered, for example, by using an error correction code in which the information is stored redundantly on the physical medium, and an algorithm examines these specific data for errors when the data are read in.

Other possible ways of resisting light attacks are, for example, double read access to the data (so-called “read-verify mode”) in which the results are compared, or reading of the data with switched-off wordlines before and after the actual read access.

Switching off the wordlines (so-called “D[isable]A[ll]W[ordlines] mode”) has the result that in correct operation one and the same pattern is always read (so-called “read-known-answer mode”); deviations from this are an indication of an attack. However, double read access measures, such as “read-verify mode” or “read-known-answer mode” can only recognize attacks taking place at the precise moment of the read access.

At present, the light attack detection method by applying read accesses in D[isable]A[ll] W[ordlines] mode is already used and implemented in current controller designs. But when adding DAW mode reads to normal reads at a read request to an N[on]V[olatile] memory, the order of read access types is always fixed.

As potential light sources for light pulse attacks, for example state of the art laser cutter devices, can already be highly focussed and exactly triggered, there would be a security gap, if, provided there is full knowledge about the mechanism, for each attack the light pulse is focussed only on the normal read accesses to the NV memory.

By this way, errors can be injected into the code or data fetched from the NV memory by the light pulse-attack without being detected by the DAW mode read accesses. In other words, light attacks with light pulses focused to only one read access are disadvantageously only detected with a certain probability, i.e. for multiple attacks of this kind there will always remain a certain amount of light attacks not being detected.

Prior art document U.S. Pat. No. 6,249,456 B1 refers to a secured E[lectrically]E[rasable] P[rogrammable] R[ead] O[nly]M[emory] comprising means for the detection of erasure by U[ltra]V[iolet] radiation; more specifically, a reference cell detects exposure to U[ltra]V[iolet] radiation, and the output of this reference cell is read at each memory access and stored in a latch.

Prior art document US 2004/0174749 A1 discloses a method and apparatus for detecting exposure of a semiconductor circuit to U[ltra-]V[iolet] light; more specifically, a dedicated mini-array of N[on]V[olatile] memory cells is provided in order to detect U[ltra-] V[iolet] exposure of a semiconductor circuit.

Prior art article “Overview about Attacks on Smart Cards” (=condensed version of chapter about smart card security in the “Smart Card Handbook” from Wolfgang Rankl und Wolfgang Effing, published in the third edition at John Wiley and Sons in September 2003) discusses that similar to the use of the differentiated fault analysis (DFA) when attacking secret keys of crypto-algorithms, it can be attempted to disrupt the processor in order to influence the sequences in the program code.

According to this prior art article, the defense against such attack comprises various steps wherein it is important that the smart card microcontroller is equipped with the corresponding sensors to detect all disruption attempts of the processor; this can be voltage sensors detecting glitches, and a large number of corresponding light sensors on the chip.

As an additional countermeasure, this prior art article proposes to carry out the query twice, where the timeframe between the two queries should be randomly chosen. As a result, the attacker would have to use two light flashes for manipulating the query and, moreover, would have the problem that he or she cannot exactly predict the point of time for the second light flash.

Starting from the disadvantages and shortcomings as described above and taking the prior art as discussed into account, an object of the present invention is to further develop a circuit arrangement as described in the technical field as well as a method of the kind as described in the technical field in order to be capable of securely averting an attack, in particular an E[lectro]M[agnetic] radiation attack, for example a side-channel attack, or in particular a crypto-analysis, for example a current trace analysis or a D[ifferential]P[ower]A[nalysis], such attack or such analysis in particular being targeted on finding out a private key.

The object of the present invention is achieved by a circuit arrangement comprising the features of claim 1 as well as by a method comprising the features of claim 6. Advantageous embodiments and expedient improvements of the present invention are disclosed in the respective dependent claims.

The present invention is principally based on a light attack detection mechanism for N[on]V[olatile] memories with randomized access order. More specifically, the present invention describes a special light attack detection logic for at least one N[on]V[olatile] memory module, which, at read accesses to the NV memory module, adds additional read accesses in a special test mode.

In this way, the present invention enables to detect if the NV memory is currently exposed to any light of a certain energy whereas the order in which the normal read access and the added special test mode accesses are executed is randomly chosen for every new read request to the NV memory. In other words, the probability of light attack detection is increased by randomizing the order in which the normal read access and the added special test-mode accesses are executed, for every new read request to the NV memory.

According to an expedient embodiment, the present invention is based on the fact that when reading a N[on]V[olatile] memory unit while activating its test mode (so-called DAW or “disable all wordlines”) the expected read data value is that of a programmed memory cell. A read result deviating from this value directly indicates an external influence on the matrix bitlines and/or on the sense amplifiers.

A security attack on this N[on]V[olatile] memory unit by exposing the memory to light pulses of sufficient energy and of sufficient length can thus be detected by the read accesses in D[isable]A[ll]W[ordlines] mode.

In a preferred embodiment of the present invention, the normal read accesses and the read accesses in DAW mode are applied to the memory module in a randomized order. This randomized order of read accesses prevents that with the knowledge of the basic principle and with the ability to generate very focused, short and exactly triggered light pulses, a potential attacker could apply the light pulse-attacks only on normal read accesses and avoid all DAW mode read accesses.

Due to the preferred randomization of the types of read accesses, for every light pulse attack there is a certain probability that the current read access is a DAW mode access and that the light pulse attack can be detected by the memory interface logic. This probability is dependent on the ratio between normal read accesses and DAW read accesses, i.e. on the number of DAW read accesses added to the normal read access at every read request to the NV memory.

For instance, if for every read request to the NV memory one normal read access and one DAW read-access is executed in random order, then the probability for a detection of a light pulse attack being focused to only one of the accesses is fifty percent.

If the light attack detection logic is preferably extended by at least one error counter, such error counter advantageously

counting the number of detected light attacks, and

disabling or slowing down the device function.

If a certain number of errors has been detected, then multiple light attacks focused to single memory read accesses can be detected so that the device can protect itself against these attacks. Less focused light pulses covering two consecutive read accesses are detected in hundred percent of cases by this method.

The present invention further relates to a microcontroller, in particular to an embedded security controller, including at least one circuit arrangement, in particular at least one integrated circuit, of the above-described type. Accordingly, the above-described method can preferably be incorporated, for example, in all smartcard developments.

The present invention further relates to a data processing device, in particular to an embedded system, for example to a chip card or to a smart card, comprising at least one circuit arrangement, in particular at least one integrated circuit, of the above-described type, carrying out calculations, in particular cryptographic operations, wherein the circuit arrangement is protected

against at least one attack, in particular against at least one E[lectro]M[agnetic] radiation attack, for example against at least one side-channel attack, or

against at least one crypto-analysis, in particular against at least one current trace analysis or against at least one D[ifferential]P[ower]A[nalysis].

The present invention finally relates to the use of at least one circuit arrangement, in particular of at least one integrated circuit, of the above-described type and/or of the method of the above-described type in at least one data processing device, in particular in at least one embedded system, for example in at least one chip card or a smart card, of the above-described type.

The circuit arrangement of the present invention and/or of the method of the present invention can preferably be used in at least one chip unit, in particular in at least one embedded security controller, for example in at least one 32 bit smart card controller, such as the HiPerSmart Card.

By such kind of use, smart card security can be advanced for mobile applications; such high security 32 bit smart card controller chip, based on a standard core architecture, offers more than 650 k[ilo]b[yte] of N[on]V[olatile] memory of the present invention. This large memory size is required for multi-application smart cards such as those used in 2.5G and 3G mobile telephony and e-government.

In particular, such extra memory enables end-users to securely and easily download new Java applets when cards are already in the field, allowing customers to enjoy a wide range of applications of their own choosing, while also enabling operators to remotely manage and update applications running on cards.

As smart card technology continues to evolve, consumers are relying on smart cards of the present invention to provide easy and secure access to personal services via mobile devices as well as additional functions to be readily available. These new functions can range from mobile entertainment in the form of MP3 downloads, network gaming, and video streaming to financial applications allowing consumers to authorize trusted payments for ticketing, entertainment downloads and online trading via existing cellular phone networks.

All of these applications have to be conducted in a secure manner with reliable authentication at every step in the process. In response to this increasing need for more capability and high security in multi-application cards, the present invention provides a high security, high performance and flexible smart card solution for applications requiring multiple levels of functionality such as electronic identification and other services demanding the ability to transfer data at ever increasing data rates.

Based on the industry standard

SmartM[illion]I[nstructions]P[er]S [econd] architecture delivering true computing capability for smart cards, the present high security 32 bit smart card controller solution offers the security, power and reliability to run versatile, open application environments such as Java Card.

In other words, the present solution enables a highly optimized smart card chip meeting the needs of the smart card industry for rapid product development according to specific and unique customer demands, thus allowing for fast prototyping to accelerate time to market.

The solution according to the present invention includes a unique blend

of Flash technology, for example of a flash memory module of 512 k[ilo]b[yte] size,

of E[lectrically]E[rasable]P[rogrammable]R[ead]O[nly]M[emories] technology, for example of an EEPROM memory module of 142 k[ilo]b[yte] size, and

of R[ead]A[ccess]M[emory] technology, for example of 16 k[ilo]b[yte] size,

on a single chip.

Using Flash technology, the chip can be programmed during or after production of the chip card or smart card—even after the chip card or smart card has entered the field. With this flexible memory feature, card users can download new applications to their card after purchase or issuance.

Open security standards for 32 bit smart computing platforms are key to service providers and network operators. In line with this key requirement, the present invention is based on a standard architecture. In contrast to proprietary offerings, chip solutions based on open standards allow the assessment of performance and security of new solutions in a credible and reliable manner.

In addition, chip solutions based on open standards provide multiple sourcing and shorter time-to-market advantages through compatibility of standard instruction sets, drivers and libraries, while also leveraging the broad knowledge base available in the market with regards to the development of core and application software.

As already discussed above, there are several options to embody as well as to improve the teaching of the present invention in an advantageous manner. To this aim, reference is made to the claims respectively dependent on claim 1 and on claim 6; further improvements, features and advantages of the present invention are explained below in more detail with reference to a preferred embodiment by way of example and to the accompanying drawings where

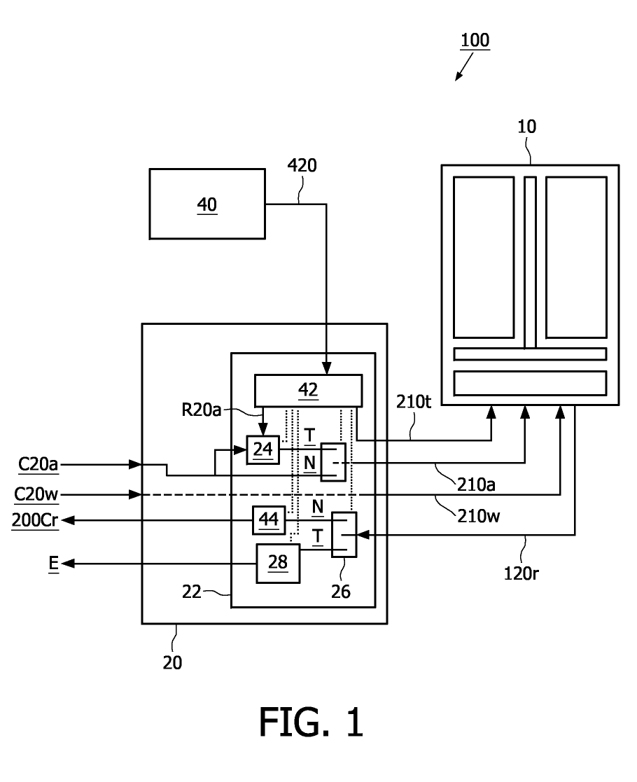

FIG. 1 schematically shows a block diagram of an embodiment of a circuit arrangement according to the present invention by means of which the method according to the present invention can be carried out.

The embodiment of a data processing device, namely of an embedded system in the form of a chip card or of a smart card comprising an I[ntegrated]C[ircuit] carrying out cryptographic operations may refer to a P[ublic]K[ey]I[nfrastructure] system and works according to the method of the present invention, i.e. is protected by a protection arrangement 100 (cf. FIG. 1) from abuse and/or from manipulation.

This embodiment of the circuit arrangement 100 for electronic data processing is provided for use in a microcontroller of the embedded security controller type. The circuit arrangement 100 comprises a multi-component non-volatile memory module 10 (so-called N[on]V[olatile] memory) which is in the form of an E[lectrically]E[rasable]P[rogrammable]R[ead]O[nly]M[emory] and by means of which data can be stored.

Associated with this N[on]V[olatile] memory module 10 is an interface logic 20 by means of which

the memory module 10 can be addressed (-> reference numeral 210a: address data “ADDR(a:0)” from interface logic 20 to memory module 10),

the memory module 10 can be written (-> reference numeral 210w: signal data “DIN(d:0)” from interface logic 20 to memory module 10), and

the memory module 10 can be read (-> reference numeral 120r: signal data “DOUT(d:0)” from memory module 10 to interface logic 20).

In addition, the circuit arrangement 100 according to FIG. 1 comprises a monitoring module 22 for monitoring the memory module 10. This monitoring module 22 is assigned to the interface logic 20, and by means of this monitoring module 22 irradiation of the memory module 10 with a light source (so-called “light attack”) can be detected, registered and signaled in a test mode T, in which no read access to the memory module 10 takes place.

For this purpose, a random number generator 40 for generating random numbers (-> reference numeral 420: random address data “RND(r:0)” from random number generator 40 to interface logic 20, in particular to monitoring module 22, more specifically to logic sequencing unit 42) for the monitoring module 22 is provided.

According to the exemplary embodiment in FIG. 1, the connection between the random number generator 40 and the monitoring module 22 is provided via an addressing multiplex unit 24 which is integrated in the monitoring module 22 and has two input terminals:

an input for the normal mode N for address data “CPU NV addr” (-> reference numeral C20a) coming from a C[entral]P[rocessing]U[nit], and

an input for the test mode T for random address data (-> reference numeral 420) coming from the random number generator 40, i.e. the test mode input receives random numbers generated by the random number generator 40 for random memory module addressing.

Accordingly, the addressing multiplex unit 24 is used for switching between the memory module addressing (=normal mode N) coming from the CPU when the memory module 10 is accessed, and the random memory module addressing (=test mode T) generated by means of the random number generator 40 when the memory module 10 is being monitored.

Depending on whether the normal mode N or the test mode T is currently activated, the memory module addressing (-> normal mode N) coming from the CPU or the random memory module addressing (-> test mode T) generated by means of the random number generator 40 is communicated to the memory module 10 as address data 210a.

Also arranged in the monitoring module 22 is an access multiplex unit 26, the input of which receives the signal data 120r from the memory module 10. The access multiplex unit 26 has two outputs:

an output for the normal mode N for connecting with the CPU (-> reference numeral 20Cr), and

an output for the test mode T for connecting with a pattern detection unit 28.

Accordingly, the access multiplex unit 26 is used for switching the signal data coming from the reading of the memory module 10 between the connection to the CPU and the memory detection unit 28 provided for comparing the random address values of the memory module 10 with address values of un-programmed memory cells.

In case of lack of agreement between the address values to be compared, i.e. in case of a detected light (flash) attack, an exception state E (so-called “hardware exception”) is triggered by this pattern detection unit 28.

As indicated above, two operating states are distinguished in the process functions of this circuit arrangement 100 according to FIG. 1:

(i) normal mode N with the source transistor of the memory module 10 switched on (test mode data “DAW=0”; cf. reference numeral 210t); in the time intervals in which a read access to the memory module 10 takes place the memory module addressing in the addressing multiplex unit 24 and the connection to the CPU in the access multiplex unit 26 are connected;

(ii) test mode T or “flash attack detect mode” with the source transistor of the memory module 10 switched off (test mode data “DAW=1”; cf. reference numeral 210t); in the time intervals in which no read access to the memory module 10 takes place the random memory module addressing in the addressing multiplex unit 24 and the pattern detecting unit 28 in the access multiplex unit 26 are connected.

By means of the circuit arrangement 100 according to FIG. 1, a method for detecting, registering and signaling the irradiation of the non-volatile memory module 10 with a light source (so-called “light attack” on said non-volatile memory module 10) can be carried out, whereby, in regular time periods triggered by a timer/clock unit by means of a cyclical timer/clock signal “slowclk”, the memory module 10 is read in test mode T (<-> DAW=1; cf. reference numeral 210t) with a random address which is generated by the interface logic 20 via the random addressing “RND(r:0)” (-> reference numeral 420).

The value of the data read from the memory module 10 in test modeT (<-> DAW=1; cf. reference numeral 210t) is then checked by the pattern detection unit 28 and compared to the specific expectation or target value of the type of memory module 10 being used.

If the readout datum differs by at least one bit from the expectation or target value of the type of memory module 10 being used, an exception state E (so-called “hardware exception”) is triggered by the pattern detection unit 28 in order to cause an immediate reaction of the CPU to the light (flash) attack.

According to the teaching of the present invention, a particular design measure is to extend the read access control logic of the N[on]V[olatile] memory interface 20 by a sequencer 42 which generates multiple memory read cycles for each read request from the CPU.

By default, these generated read cycles can be read accesses in D[isable]A[ll]W[ordlines] mode. Controlled by a chip-internally generated random number which is sampled by the NV memory interface 20 at the start of the CPU read request, one of the generated read cycles is qualified as “normal” memory read cycle, which reads the requested data from the memory 10 and passes the requested data to the CPU.

For the remaining DAW mode read cycles, the read result is compared with the expected result value and if these results do not match, an appropriate error function, such as at least one exception, at least one interrupt, at least one reset, is triggered.

The logic sequencer 42 generates an access timing for read accesses to the NV memory 10. Each read access is performed as double access sequence, wherein

one of these accesses is the normal read access (-> reference numeral N for mu[ltiple]×channels in the normal mode), and

the other of these accesses is the D[isable]A[ll]W[ordlines] mode read access (-> reference numeral T for special test mode) in order to detect a possible light pulse attack on the NV memory 10.

The DAW mode read access (-> reference numeral T) is either done at the same address as the normal read access (-> reference numeral N), or at a random address derived from the random word 420; in order to enable such choice or switch between the possible addresses, an address mu[ltiple]x[ing] unit 24 is connected behind the sequencing unit 42, this address mux 24 being providable

either with the same address as the normal read access (-> reference numeral N),

or with the random address derived from the random word 420.

The order, in which the normal read access and the DAW mode read access are executed, is controlled by the logic sequencing unit 42 in dependence on the random word 420. Thus, for each read access there is a probability of fifty percent that a DAW mode read access is executed.

A light error if detected by the read pattern check as performed in the pattern detection unit 28 generates a hardware exception or a hardware reset via the light error flag E where the reference numeral E may stand for exception state or hardware exception.

The data latch unit 44 as connected behind the access multiplex unit 26 is used to store the data read at the normal read access (-> reference numeral N) until these data have latched by the CPU.

The advantage of the implementation as well as of the method according to the present invention lies in the fact that even with highly focused and exactly triggered light pulses it is no longer possible to inject errors into certain N[on]V[olatile] memory read accesses without a detection probability of at least fifty percent by the light attack detection mechanism.

So security attack methods requiring a multiple number of successful error injections to be generally successful are detected with high probability. Even security attacks which only require one successful error injection to achieve the intended effect have a detection risk of at least fifty percent.

### LIST OF REFERENCE NUMERALS

100 circuit arrangement for electronic data processing
10 NV memory module or N[on]V[olatile] memory
20 interface logic unit
22 monitoring module
24 address(ing) multiplex unit
26 access multiplex unit
28 pattern detection unit
40 random number generating unit
42 logic sequencing unit
44 data latch unit
120r signal data “DOUT(d:0)” from memory module 10 to interface logic unit
210a address data “ADDR(a:0)” from interface logic unit 20 to memory module 10
210t test mode data “DAW” from interface logic unit 20, in particular from logic sequencing unit 42, to memory module 10
210w signal data “DIN (d:0)” from interface logic unit 20 to memory module 10
420 random number signal “RND(r_{:}0)” from random number generator 40 to interface logic unit 20
20Cr signal data “CPU NV read data” from interface logic unit 20 to
C[entral] P[rocessing]U[nit]
C20a memory module address(ing) data “CPU NV addr” from
C[entral]P[rocessing]U[nit] to interface logic unit 20
C20w signal data “CPU NV write data” from C[entral]P[rocessing]U[nit] to interface logic unit 20
E exception state or hardware exception or light error flag
N normal (read) mode with test mode datum DAW=0
R20a random memory module address(ing) data from random number generator 40, in particular from logic sequencing unit 42, to addressing multiplex unit 24
T test (read) mode with test mode datum DAW=1

1. A circuit arrangement, in particular an integrated circuit, for electronic data processing, comprising
at least one non-volatile memory module for storing data, in particular
at least one E[rasable]P[rogrammable]R[ead]O[nly]M[emory], for example at least an E[lectrically]E [rasable]P [rogrammable]R[ead]O [nly]M[emory], or
at least a flash memory unit,
at least one interface logic unit
for addressing the memory module,
for writing data to the memory module, and/or
for reading data from the memory module, the interface logic Aid comprising at least one monitoring module
for monitoring the memory module, and/or
for detecting and/or for registering and/or for signaling an irradiation of the memory module with at least one light source,
characterized in
that the monitoring module comprises at least one logic sequencing unit for generating an access timing for at least one read access to the memory module, in particular for adding at least one additional read access to the memory module in at least one test mode, in particular in at least one D[isable]A[ll]W[ordline] mode, this test mode preferably allowing to detect if the memory module is currently exposed to any light of a certain energy.

2. The circuit arrangement according to claim 1, characterized by at least one random number generator for generating at least one random number for the monitoring module, in particular for the logic sequencing unit.

3. The circuit arrangement according to claim 1, characterized in that the monitoring module comprises
at least one addressing multiplexing unit for switching
between at least one memory module addressing data coming from at least one C[entral]P[rocessing]U[nit] when the memory module is accessed
and at least one random memory module addressing data generated by the random number generator and coming from the logic sequencing unit while the memory module is monitored, and
at least one access multiplexing unit for switching the signal data coming from the reading of the memory module A
between at least one connection to theC[entral]P[rocessing]U[nit]
and at least one pattern detection unit provided for comparing the random address values of the memory module with address values of unprogrammed memory cells, by which at least one exception state or at least one light error flag can be triggered in case of a lack of agreement between the address values to be compared.

4. A microcontroller, in particular an embedded security controller, comprising at least one circuit arrangement, in particular at least one integrated circuit, according to claim 1.

5. A data processing device, in particular an embedded system, for example a chip card or a smart card, comprising at least one circuit arrangement, in particular at least one integrated circuit, according to claim 1, the circuit arrangement
carrying out calculations, in particular cryptographic operations, and
being protected
against at least one attack, in particular against at least one E[lectro]M[agnetic] radiation attack, for example against at least one side-channel attack, or
against at least one crypto-analysis, in particular against at least one current trace analysis or against at least one D[ifferential]P[ower]A[nalysis].

6. A method for detecting and/or for registering and/or for signaling the irradiation of at least one non-volatile memory module with at least one light source,
characterized in
that an access timing for at least one read access to the memory module is generated, in particular that at least one additional read access to the memory module is added in at least one test mode, in particular in at least one D[isable]A[ll]W[ordline] mode, this test mode preferably allowing to detect if the memory module is currently exposed to any light of a certain energy.

7. The method according to claim 6, characterized in
that when reading the memory module while activating the test mode, the expected read data value is that of a programmed memory cell, and
that a read data value deviating from said expected read data value indicates at least one external influence, in particular on the matrix bitlines and/or on the sense amplifiers.

8. The method according to claim 6, characterized in that the read accesses in the normal mode and the read accesses in the test mode are applied to the memory module in a randomized order.

9. The method according to claim 8, characterized in that due to the randomized order of the types of read accesses, for every light pulse attack there is a certain probability
that the current read access is a read access in the test mode and
that the light pulse attack can be detected by at least one interface logic, this probability being dependent
on the ratio between read accesses in the normal mode and the read accesses in the test mode, and/or
on the number of read accesses in the test mode added to the read accesses in the normal mode at every read request to the memory module.

10. Use of at least one circuit arrangement, in particular of at least one integrated circuit, according to claim 1 in at least one data processing device, in particular in at least one embedded system, for example in at least one chip card, or a smart card, to be protected
against at least one attack, in particular against at least one E[lectro]M[agnetic] radiation attack, for example against at least one side-channel attack, or
against at least one crypto-analysis, in particular against at least one current trace analysis or against at least one D[ifferential]P[ower]A[nalysis].
